(19) United States
(12) Patent Application Publication
(10) Pub. No.: US 2026/0249902 A1
(43) Pub. Date: Aug. 27, 2026

(54) Method for Determining a Rear Axle Steering Angle

(71) Applicant: Robert Bosch GmbH, Stuttgart (DE)

(72) Inventor: Philipp Debes, Ludwigsburg (DE)

(21) Appl. No.: 19/489,700

(22) PCT Filed: Jun. 4, 2024
(86) PCT No.: PCT/EP2024/065252

§ 371 Date: Dec. 3, 2025

(30) Foreign Application Priority Data
Jun. 6, 2023 (DE) 10 2023 205 259.8

(51) Int. Cl. B62D 6/00

(52) U.S. Cl. CPC B62D 6/002

(57) ABSTRACT

A method for determining a rear axle steering angle is disclosed. The rear axle steering angle is determined based on a detected front axle steering angle, and tire characteristics and the location of the vehicle center of gravity are taken into account when determining the rear axle steering angle.

The invention relates to a method for determining a rear axle steering angle and an assembly for carrying out the method. The invention further relates to a computer program and a machine-readable storage medium.

### PRIOR ART

A rear axle steering system allows the wheels on the rear axle to turn, thereby directly influencing the vehicle's driving dynamics. For example, if the wheels of the rear axle are turned in the opposite direction compared to the wheels of the front axle, the turning circle of the vehicle can be reduced. Thus, modern vehicle dynamic control systems provide the ability to influence the steering angle of the rear axle with the help of such a rear axle steering system.

The rear axle steering is thus used, among other things, in order to enhance the driving dynamics, particularly the yaw amplification, of a vehicle. Yaw amplification describes the stationary vehicle response to a driver-induced steering input. A rear axle steering system is capable of both increasing and decreasing the yaw amplification of a vehicle.

It is known to use rear axle steering in a speed range of up to about 80 km/h in order to increase the yaw amplification of the vehicle. To this end, the rear axle is turned in the opposite direction compared to the front axle, thereby increasing the agility of the vehicle. Compared to a vehicle without rear axle steering, the steering effort required by the driver when navigating a curve is reduced.

Furthermore, it is known to use rear axle steering in a speed range above about 80 km/h in order to reduce the vehicle yaw amplification. For this purpose, the rear axle is steered in the same direction as the front axle. This increases the driver's steering effort while navigating a curve, and the vehicle gains stability.

In known methods, a proportional calculation of the rear axle steering angle, i.e. proportional to the steering angle of the front axle, is known. The underlying proportionality factor i_{corr} can be specified depending on the vehicle speedvₓ. The non-linear characteristic of the front axle's lateral force is implicitly considered via an indicator Co_{Overpull} that indicates excessive front axle steering. Depending on this indicator, the proportionality factor i_{corr} can be reduced:

$${i}_{c o r r} = f ( {v}_{x} , {Co}_{Overpull} ) \qquad ( 1 )$$

The rear axle steering angle is determined as follows:

$${δ}_{R A} = {i}_{c o r r} \cdot {δ}_{F A} \qquad ( 2 )$$

### DISCLOSURE OF THE INVENTION

Against this background, a method having the features of claim 1 and an assembly according to claim 8 are presented. A computer program according to claim 9 and a machine-readable storage medium according to claim 10 are also presented. Embodiments arise from the dependent claims and from the description.

The presented method serves to determine a rear axle steering angle, wherein the rear axle steering angle is determined based on a detected front axle steering angle. Additionally, tire characteristics and the location of the vehicle center of gravity are considered when determining the rear axle steering angle.

The presented method thus serves to determine or calculate a value for a rear axle steering angle, which can then be subsequently adjusted via a suitable actuation on the rear axle.

The presented method is based on the following findings, which arise from the problems associated with the prior art.

In known methods, the actual tire characteristics, in particular the non-linear lateral force curves, of the front and rear axles are disregarded; see FIG. 1 for reference. As soon as the linear lateral force range of the front axle is exceeded, typically from a lateral acceleration of more than about 4 m/s² on dry asphalt, the influence of the proportional rear axle steering on the ratio of the lateral forces of the front and rear axles changes. This ratio shifts towards the rear axle lateral force.

This effect occurs because the actuator range of the rear axle steering is significantly smaller compared to the front axle steering, and the rear axle operates significantly longer in the linear range of the lateral force curve. With excessive front axle steering, a decrease in the lateral force of the front axle can occur while simultaneously increasing the rear axle lateral force. This can lead to a driving impression that is difficult to predict and feels synthetic, especially in the dynamic driving limit range.

In the presented method, it is now provided that a predictable and naturally acting driving impression can be generated by taking into account the stationary lateral force of the front axle. This is particularly evident in the vehicle dynamic limit range. Over the entire lateral acceleration range, the ratio between the lateral forces of the front and rear axles remains constant.

In addition, the implicit influence of the indicator Co_{Overpull} is already explicitly implemented by considering the tire characteristics. This can reduce the application effort.

Furthermore, in known methods, in addition to the tire characteristics, the vehicle characteristics such as mass and location of the center of gravity are also neglected. Thus, the vehicle center of gravity and the lateral force curve of the front and rear wheels have no effect on the proportional rear axle steering angle. Therefore, only the qualitative influence of the proportionality factor i_{corr} on the yaw amplification can be derived. However, no direct statement can be made regarding the quantitative influence.

According to the presented method, the proportionality factor also allows a quantitative inference about the influence of yaw amplification. This is possible because the proportionality factor is calculated at the yaw torque level.

As already mentioned, previous methods do not take into account any tire or vehicle characteristics. Therefore, the proportionality factor i_{corr} can only be transferred to other variants, models, or vehicle types with greater effort.

In the presented method, it is now provided that the tire characteristics as well as the location of the vehicle center of gravity are taken into account. This facilitates the transition between different variants, models, and vehicle types and significantly reduces the application effort. In this regard, it is provided that a proportional rear axle steering angle is calculated depending on the stationary lateral force of the front axle, taking into account tire and vehicle characteristics.

The described assembly is configured in order to carry out the presented method and is, for example, implemented in software and/or hardware. Furthermore, this assembly can be integrated into a control unit of a vehicle or can be designed as such. Thus, the assembly may be present, at least in part, as a computer program, which in turn may be stored on a machine-readable storage medium.

Further advantages and embodiments of the invention are shown in the description and the accompanying drawings.

It is understood that the abovementioned features and those to be explained below can be used not only in the combination indicated in each case, but also in other combinations or on their own, without departing from the scope of the present invention.

### BRIEF DESCRIPTION OF THE DRAWINGS

FIG. 1 shows a graph of the non-linear lateral force curve over the skew angle.

FIG. 2 shows a flow chart of the calculation of the proportional rear axle steering angle.

FIG. 3 shows a schematic representation of a vehicle having an assembly for carrying out the presented method.

### EMBODIMENTS OF THE INVENTION

The invention is illustrated schematically by means of embodiments in the drawings and is described in detail below with reference to the drawings.

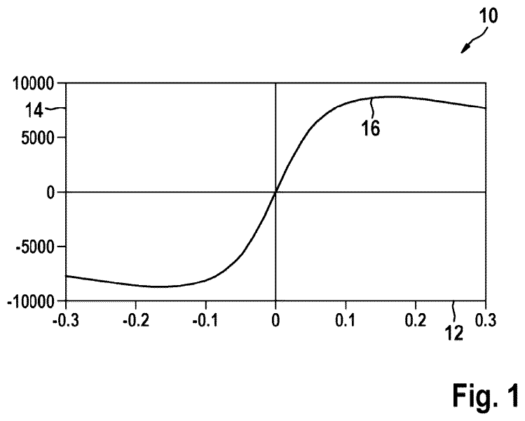

FIG. 1 shows a graph 10, where the skew angle □ [rad] is plotted on its abscissa 12 and the lateral force Fy [N] is plotted on its ordinate 14. A curve 16 illustrates the progression of the lateral force over the skew angle.

In a design of the presented method, the lateral force of the front axle Fy_{FA} is first calculated from the steering angle of the front axle δ_{FA} and the stationary contact force Fz_{FA,stat}, taking into account the tire characteristics of the front axle, i.e. maximum skew angle α_{max,FA}, linear skew resistance cy_{FA}, and considering the prevailing friction coefficient μ_{max,FA}. For this calculation, a tire model f_{Tyre} is used which depicts the non-linearity of the lateral force over the skew angle, as illustrated in FIG. 1.

$${Fy}_{FA} = {f}_{Tyre} ( {δ}_{FA} , {μ}_{max , FA} , {α}_{max , FA} , {cy}_{FA} , {Fz}_{FA , stat} ) \qquad ( 3 )$$

From this front axle lateral force Fy_{FA}, a proportional yaw torque Mzₚᵣₒₚ is calculated using the location of the vehicle center of gravity l_{FA2COG}.

$${Mz}_{p r o p} = {Fy}_{FA} \cdot {l}_{FA 2 COG} \qquad ( 4 )$$

This yaw torque Mzₚᵣₒₚ is converted into a rear axle lateral force Fy_{RA} using the yaw amplification factor i_{corr} and the location of the vehicle center of gravity l_{RA2COG}.

$${Fy}_{R A} = \frac{{Mz}_{prop} \cdot {i}_{c o r r}}{{l}_{RA 2 COG}} \qquad ( 5 )$$

From this rear axle lateral force Fy_{RA}, the proportional rear axle steering angle δ_{RA,prop} is calculated using the stationary contact force of the rear axle Fz_{RA,stat} as well as the linear skew resistance of the rear axle cy_{RA}.

$${δ}_{R A , p r o p} = \frac{F {y}_{R A}}{F {z}_{R A , s t a t} \cdot {cy}_{R A}} \qquad ( 6 )$$

As an alternative to the linear conversion of the rear axle lateral force into a rear axle steering angle via the linear lateral resistance cy_{RA}, a conversion using an inverse tire model is also conceivable. In this case, the proportional rear axle steering angle δ_{RA,prop} is calculated as a function of the tire characteristics of the rear axle, i.e. maximum skew angle α_{max,RA}, linear skew resistance cy_{RA}, and as a function of the prevailing coefficient of friction μ_{max,RA}.

$${δ}_{R A , p r o p} = \frac{{f}_{Tyre} ( F {y}_{RA} , {μ}_{max , RA} , {α}_{max , RA} , {cy}_{R A} )}{{Fz}_{R A , s t a t}} \qquad ( 7 )$$

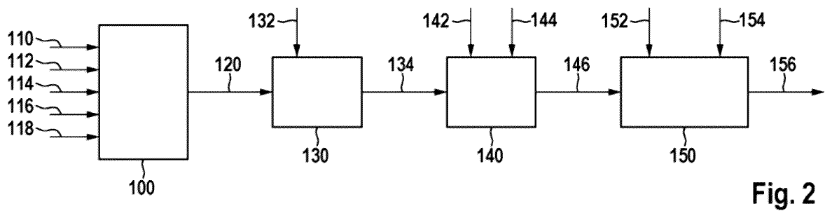

FIG. 2 shows a block diagram of a possible sequence of the method for determining or calculating the in particular proportional rear axle steering angle. In this context, “proportional” means that the rear axle steering angle is proportional to the front axle steering angle.

In a first block 100, the lateral force of the front axle is calculated. Input variables are:

| | |
|---|---|
| Steering angle of front axle δ_{FA} | 110 |
| Prevailing friction coefficient of front axle μ_{max, FA} | 112 |
| Maximum skew angle of front axle α_{max, FA} | 114 |
| Linear skew resistance of front axle cy_{FA} | 116 |
| Stationary contact force of front axle Fz_{FA, stat} | 118 |

Output variable is the front axle lateral force Fy_{FA} 120.

In block 130, the conversion into a yaw torque occurs. In addition to the front axle lateral force Fy_{FA} 120, a further input variable is the location of the vehicle center of gravity l_{FA2COG} 132 in relation to the front axle. Output variable is the yaw torque Mzₚᵣₒₚ 134.

In block 140, the lateral force of the rear axle is calculated. Input variables in addition to the yaw torque Mzₚᵣₒₚ 134 are the yaw amplification factor i_{corr} 142 and the location of the vehicle center of gravity l_{RA2COG} 144 in relation to the rear axle. Output variable is the rear axle side force Fy_{RA} 146.

In block 150, the rear axle steering angle is calculated. Input variables in addition to the rear axle side force Fy_{RA} 146 are the stationary contact force of the rear axle Fz_{RA,stat} 152 and the linear skew resistance of the rear axle cy_{RA} 154. Output variable is the proportional rear axle steering angle δ_{RA,prop} 156.

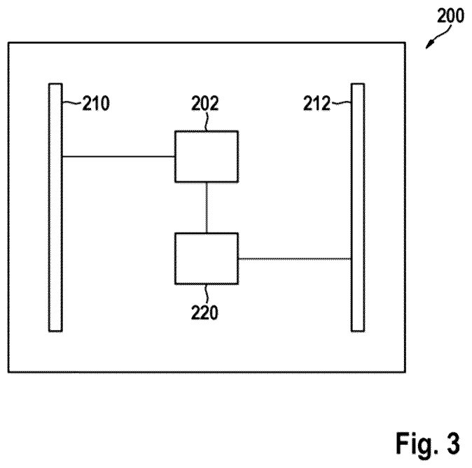

FIG. 3 shows a purely schematic, strongly simplified representation of a vehicle 200 having an assembly 202 for carrying out the presented method. This vehicle 200 is equipped with a front axle 210 and a rear axle 212. The assembly serves to determine a rear axle steering angle or a value for this rear axle steering angle. The determined value is then used in order to control the rear axle 212 via a unit 220, so that it sets the determined value.

1. A method for determining a rear axle steering angle, comprising:
detecting a front axle steering angle, and determining the rear axle steering angle based on the detected front angle steering angle,
wherein tire characteristics and a location of a vehicle center of gravity are taken into account when determining the rear axle steering angle.

2. The method according to claim 1, wherein the determined rear axle steering angle is set.

3. The method according to claim 1, wherein:
a lateral force of a front axle is first calculated from the front axle steering angle and a stationary contact force, taking into account the tire characteristics of the front axle and a prevailing friction coefficient,
a proportional yaw torque is calculated from the lateral force of the front axle using the location of the vehicle center of gravity,
the yaw torque is converted into a rear axle lateral force using a yaw amplification factor and the location of the vehicle center of gravity, and
the proportional rear axle steering angle is calculated from the rear axle lateral force.

4. The method according to claim 3, wherein a tire model depicting a non-linearity of the lateral force across a skew angle is used for this calculation.

5. The method according to claim 3, wherein the proportional rear axle steering angle is calculated from the rear axle lateral force using the stationary contact force of the rear axle as well as a linear skew resistance of the rear axle.

6. The method according claim 3, wherein the proportional rear axle steering angle is calculated using an inverse tire model.

7. An assembly for determining a rear axle steering angle, which is configured so as to carry out the method according to claim 1.

8. The assembly according to claim 7, further comprising a unit for controlling a rear axle.

9. A computer program comprising program code means configured so as to carry out the method according to claim 1 when the computer program is executed on a computing unit.

10. A machine-readable storage medium having a computer program according to claim 9 stored thereon.
